(19) United States
(12) Patent Application Publication
(10) Pub. No.: US 2004/0233550 A1
(43) Pub. Date: Nov. 25, 2004

(54) Adjustment mechanism for a binocular apparatus

(76) Inventor: James D. Burr, Evergreen, CO (US)

Correspondence Address: KOLISCH HARTWELL, P.C., 520 S.W. YAMHILL STREET, SUITE 200, PORTLAND, OR, 97204, US

(21) Appl. No.: 10/444,274

(22) Filed: May 23, 2003

(51) Int. Cl. G02B 7/02

(52) U.S. Cl. 359/822

(57) ABSTRACT

A focuser configured to effect changes in optical path length between a primary mirror disposed within a primary optical tube and an eyepiece. The focuser includes a base secured to the primary optical tube and movable in a direction parallel to an optical axis of the primary optical tube. The focuser also includes a secondary optical tube movably engaged with the base and associated with the eyepiece. The secondary optical tube is movable in a direction parallel to the optical axis of the primary optical tube, and also movable in a direction orthogonal to the optical axis of the primary optical tube.

### TECHNICAL FIELD

The present invention relates generally to optical instruments, and more particularly to a mechanism for adjusting alignment and focus of an optical instrument, by effecting relative movement between two or more optical components of the instrument. Although the invention has wide utility in the field of optical devices, it has proven particularly useful in the context of adjusting alignment and focus of a binocular telescope.

### BACKGROUND OF THE INVENTION

A conventional reflecting telescope employs a system of mirrors contained within an optical tube to gather and focus rays of light at a focal point, thereby forming a viewable image of an object. Typically, a primary mirror gathers and reflects light to a secondary mirror that reflects and focuses the light at a focal point, forming an image. The image formed by light reflected from the secondary mirror can be viewed through an eyepiece. The telescope is focused by causing the optical tube focal point to coincide with the focal point of the eyepiece. A photographic plate or CCD sensor may be used instead of an eyepiece in certain applications to “view”the image, by capturing light reflected from the secondary mirror.

Effecting relative movement between the focal points of an optical tube and its associated eyepiece is a method used to focus a reflecting telescope. This may be accomplished by moving the primary and secondary mirrors to change the position of the optical tube focal point. In this method, the optical tube and eyepiece remain in fixed positions relative to one another. A problem with this method is that moving the optical tube mirrors, particularly the primary mirror, can cause the viewed image to shift, requiring that the telescope be re-aimed in order to view the original image.

Various mechanisms have been designed that allow a reflecting telescope to be focused without moving the primary mirror and/or the secondary mirror of the telescope. These include sliding drawtubes, threaded focusing tubes, and rack and pinion systems, all of which are configured to move an eyepiece relative to an optical tube. An example of such a focusing apparatus may be found in U.S. Pat. No. 6,297,917, the disclosure of which is incorporated herein by this reference thereto.

A binocular telescope generally includes two coupled reflecting telescopes, each typically including primary and secondary mirrors as described above. Two images of an object, formed independently via the two telescopes, may be viewed simultaneously through two eyepieces. Collecting light with two telescopes and viewing the associated images simultaneously with two eyes may have certain benefits. For instance, the amount of light collected by two telescopes is roughly twice the amount collected by a single similar telescope, possibly leading to a more distinct perception of the resulting image. Furthermore, using both eyes may reduce unwanted optical noise generated by viewing an image with one eye closed, and may enhance various aspects of visual perception including color perception and contrast perception, among others.

Using a binocular (or dual-ocular) optical apparatus such as a binocular telescope typically introduces various considerations beyond those involved in using a conventional, uni-ocular apparatus. For instance, a binocular telescope may employ tertiary mirrors to reflect collected light so that two eyepieces may be positioned in a spaced apart, parallel relationship to each other for simultaneous viewing by an observer. It may be desirable to adjust the spacing between the eyepieces to approximately match the interocular spacing of a user, and this adjustment may alter the length of the optical path in one or both telescopes, affecting focus of the telescopes. In addition, the two optical devices in a binocular apparatus should be aligned if they are to form similar images when viewed through both eyepieces simultaneously.

### BRIEF DESCRIPTION OF THE DRAWINGS

FIG. 1 is in isometric view of a binocular telescope constructed according to aspects of an embodiment of the present invention.

FIG. 2 is a top plan view of the binocular telescope of FIG. 1.

FIG. 3 is a side elevational view of the binocular telescope of FIG. 1.

FIG. 4 is a front elevational view of a handlebar portion of the binocular telescope of FIG. 1.

FIG. 5 is a rear elevational view of the binocular telescope of FIG. 1.

FIG. 6 is a top view of a focuser for a telescope constructed according to aspects of an embodiment of the present invention.

FIG. 7 is a side elevational view of the focuser of FIG. 6.

FIG. 8 is a top view of a portion of a binocular telescope, showing two eyepieces having a desired separation, but unequally spaced from two primary optical tubes and offset longitudinally.

FIG. 9 is a top view similar to FIG. 8, showing the two eyepieces positioned at equal minimum distances from two primary optical tubes.

FIG. 10 is a top view similar to FIGS. 8 and 9, showing the two eyepieces positioned with a desired separation and at equal distances from two primary optical tubes.

FIG. 11a is a schematic view of two images viewed through eyepieces of a binocular telescope when two optical axes of the binocular telescope are misaligned.

FIG. 11b is a schematic view similar to FIG. 11a, where one optical axis has been rotated so that the two images are aligned with a vertical alignment axis.

FIG. 11c is a schematic view similar to FIG. 11b, where the other optical axis has been rotated so that the two images have converged to form a single image.

### DETAILED DESCRIPTION

A mechanism is provided that effects relative movement between components of an optical device to focus and/or align the optical device. Though the provided apparatus may be used in conjunction with various optical devices, it is described herein particularly for use in attaining focus and/or or alignment of a binocular optical device, such as a binocular telescope. Focus is attained by effecting relative movement between a primary light-collecting mirror and an image-receiving device, such as an eyepiece, CCD sensor or photographic plate. Alignment is attained by effecting relative movement between two optical axes in a binocular device.

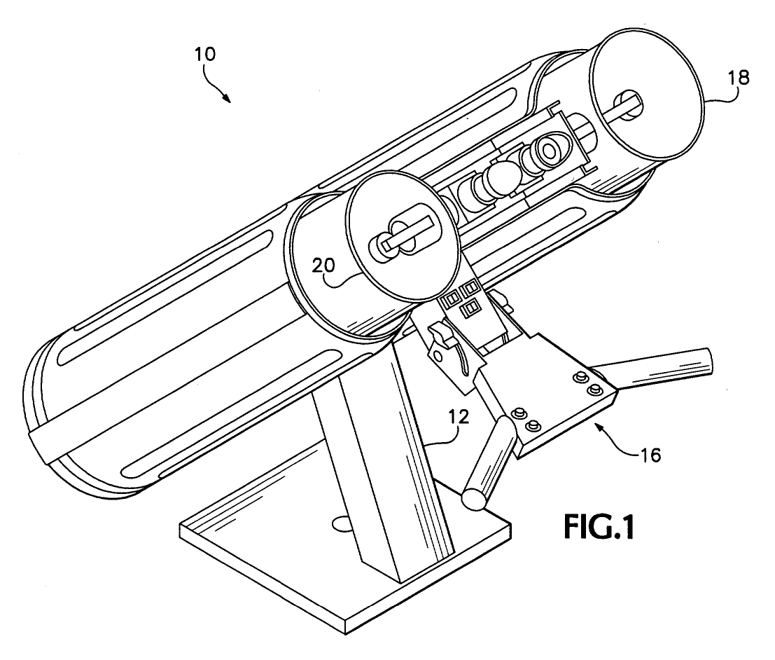

FIG. 1-3 depict a binocular apparatus 10, the apparatus including a base portion 12, a substantially rigid body portion 14 supported by the base portion, and a handlebar apparatus 16 attached to the body portion. Body portion 14 is adapted to couple together and support a first reflecting telescope 18 and a second reflecting telescope 20. Telescopes 18 and 20 are similar in construction and function, apparatus 10 typically being configured to produce two similar images that may be viewed simultaneously. Handlebar apparatus 16 may be used to control orientation of the body member as well as focus and/or alignment of the telescopes, as described below.

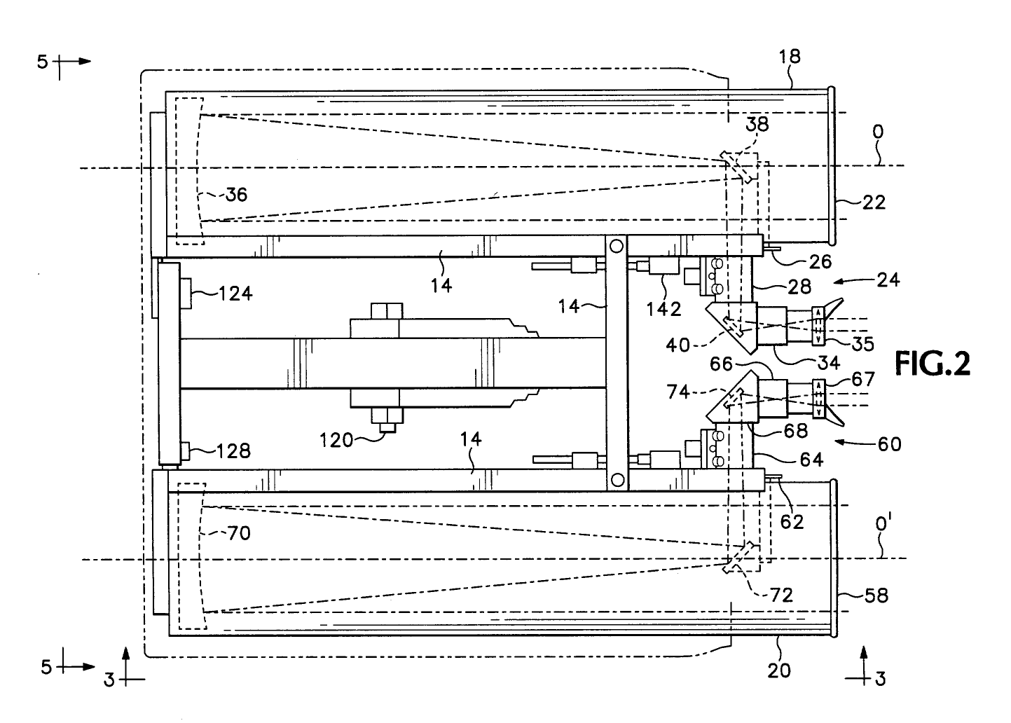

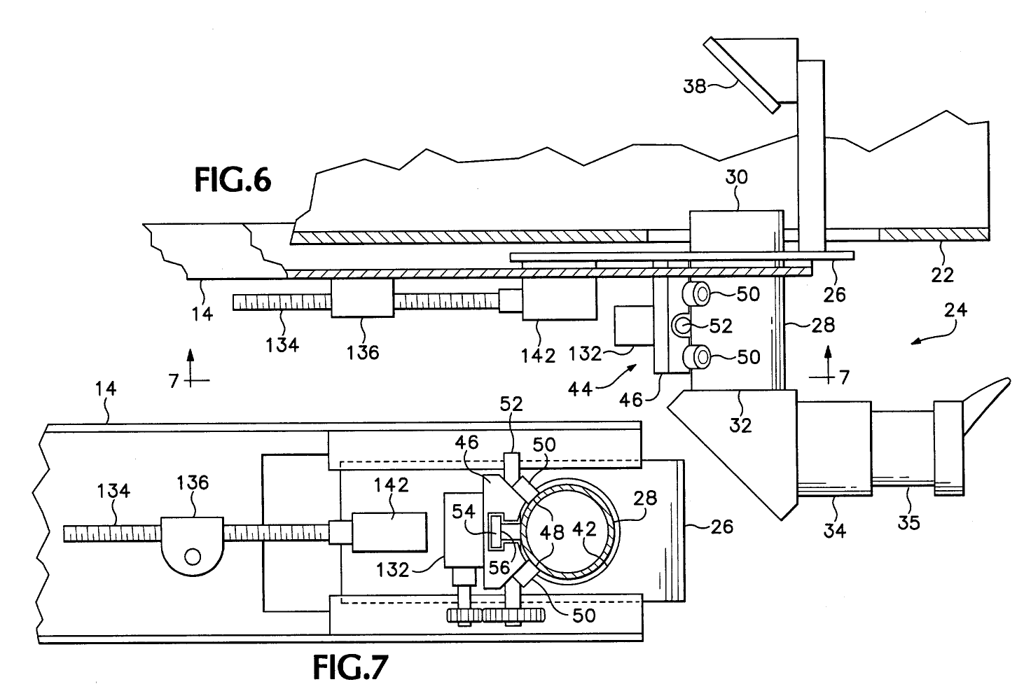

FIG. 2 shows a top plan view of body portion 14 engaged with and supporting telescopes 18 and 20. First telescope 18 includes a primary optical tube 22 defining an optical axis O, and a focuser 24 configured to effect changes in length of an optical path of the telescope. FIGS. 6 and 7 show details of focuser 24, which includes a base 26 adapted to be secured to primary optical tube 22, and a secondary optical tube 28 movably engaged with the base. The secondary optical tube has its longitudinal axis orthogonal to the longitudinal axis of the primary optical tube. A first end 30 of the secondary optical tube is received through a side of the primary optical tube. A second end 32 of the secondary optical tube is opposite from base 26, and an eyepiece holder 34 is connected to the secondary tube at end 32. The eyepiece holder is adapted to receive and securely retain an eyepiece 35, through which an image formed via the telescope may be viewed.

Referring to FIG. 2, a primary mirror 36 within the primary optical tube reflects and focuses light towards a secondary mirror 38, which reflects light to a tertiary mirror 40 within the secondary optical tube. The tertiary mirror reflects light through the eyepiece holder for viewing through an eyepiece or, in some embodiments, via a photographic plate or a CCD sensor. In order to attain a focused image, the focal point of the telescope including the primary, secondary, and tertiary mirrors should coincide with the focal point of an eyepiece lens used to view the image. This may be accomplished by adjusting the length of the optical path of the telescope, taken to be the path of reflected light between the primary mirror and the eyepiece lens.

The secondary optical tube is held in alignment by base 26 and is engaged with the base such that the secondary optical tube is movable relative to the base in a direction orthogonal to optical axis O. This allows the eyepiece to be positioned at any desired distance from primary optical tube 22, resulting in relative movement between the eyepiece and the primary mirror, and changing focus of the telescope. The base is also movable parallel to optical axis O of the telescope. The secondary optical tube is engaged with the base such that the secondary optical tube moves parallel to the optical axis when the base moves, so as to effect changes in the length of the optical path of the telescope. This allows the telescope to be focused without changing the distance between the eyepiece and the primary optical tube. Thus, focuser 24 allows the eyepiece to be positioned as desired, and the telescope to be focused.

As shown in FIGS. 6-7, base 26 includes an aperture 42 for receiving the secondary optical tube, and a tube engagement mechanism, generally indicated at 44, to hold the secondary optical tube in orthogonal alignment with the base (and thus with primary optical tube 22). Tube engagement mechanism 44 is adapted to secure the secondary optical tube to the base, and may generally be of the type disclosed in U.S. Pat. No. 6,297,917. For example, the tube engagement mechanism may include an upstanding member 46 welded or otherwise connected to the base, the upstanding member having a contact surface 48 for engaging the secondary optical tube. Contact surface 48 may be provided by one or more bearings 50 of the upstanding member, such as cylindrical bearings adapted for movably engaging the secondary optical tube.

Focuser 24 includes an advancement mechanism secured to base 26 for selectively causing secondary optical tube 28 to move relative to the base. Such advancement mechanism may take the form of a rotatable shaft 52 which is spaced apart from secondary optical tube 28, and which operatively engages a track 54 connected and fixed relative to the secondary optical tube. Since shaft 52 directly engages track 54 in the depicted embodiment, it will be appreciated that the shaft may be coated with frictionally adhesive material or the like to effect reliable relative movement of the track. Track 54 is fixed relative to secondary optical tube 28 such that rotation of the shaft along an engagement surface 56 of the track effects movement of the track and secondary optical tube orthogonal to the optical axis. Rotation of shaft 52 thus results in a relative movement between the eyepiece and the primary mirror. Further details of possible advancement mechanisms may be found in U.S. Pat. No. 6,297,917.

Referring again to FIG. 2, it will be seen that second telescope 20 is constructed in a manner similar to first telescope 18, including a primary optical tube 58, and a focuser 60. Focuser 60 includes a base 62, a secondary optical tube 64, and an advancement mechanism similar to the construction of the advancement mechanism of focuser 24. An eyepiece holder 66 is shown attached to an end 68 of the secondary optical tube, and is adapted to receive an eyepiece 67. As in the case of the first telescope, a primary mirror 70, a secondary mirror 72, and a tertiary mirror 74 collect and reflect light for viewing, typically through the eyepiece.

As shown in FIG. 2, secondary optical tubes 28 and 64 may be connected to primary optical tubes 22 and 58 substantially orthogonally, and eyepiece holders 34 and 66 may be connected to secondary optical tubes 28 and 64 substantially orthogonally, so that two eyepieces may be positioned in spaced apart, parallel relationship to each other. This allows an observer to view two images formed via the telescopes simultaneously through both eyes.

Focusers 24 and 60 may be used in conjunction with each other as an eyepiece spacing adjustment mechanism, to attain a desired spacing between eyepieces. For example, the spacing may be chosen to match the interocular spacing of an observer using the binocular apparatus. In addition, the focusers may be used to ensure that the optical path lengths of the two telescopes are approximately equal, or in other words that the eyepieces are symmetrically spaced at equal distances from their respective telescopes. The eyepieces can become asymmetrically spaced since in some embodiments, the focuser advancement mechanisms rely on frictional engagement between a rotatable shaft such as shaft 52, and a track such as track 54. After repeated use, a small amount of slippage may occur between the shaft and track of one or both focusers, leading to asymmetrical spacing of the eyepieces from the telescopes.

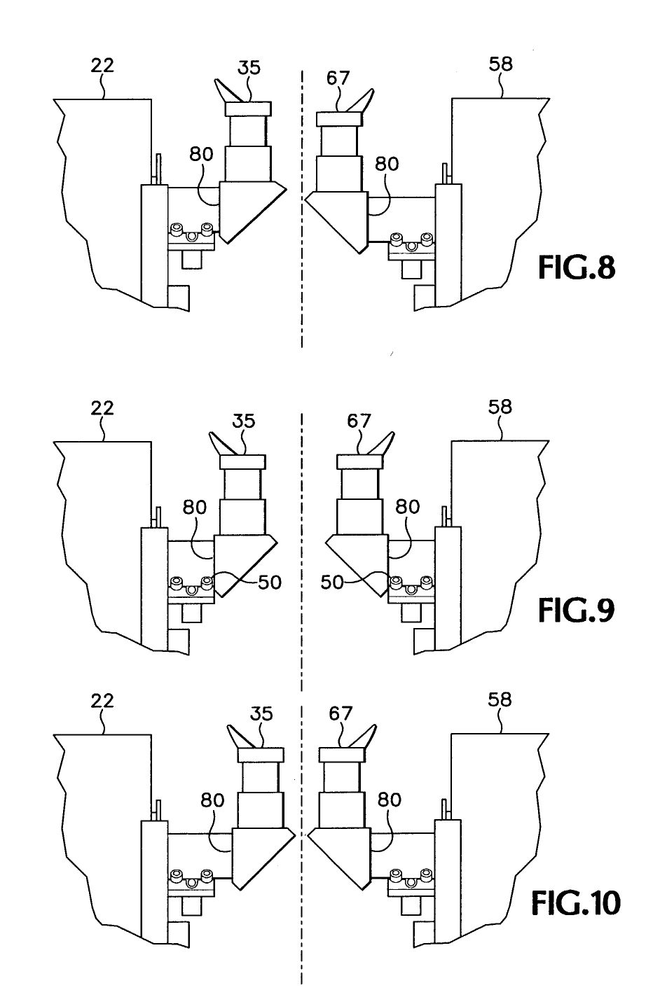

For example, FIG. 8 shows eyepieces 35 and 67 spaced apart by a desired amount, but positioned at unequal orthogonal distances from their associated primary optical tubes. These unequal orthogonal distances represent a difference in the optical path lengths of the two telescopes, and images formed via the two telescopes would not be simultaneously focused unless this difference were compensated for. One way to equalize the optical path lengths is to move the secondary optical tubes parallel to the optical axes of the primary tubes by different amounts, but this results in a longitudinal offset of the eyepieces, as shown in FIG. 8. This offset may make it difficult or impossible to comfortably look through both eyepieces simultaneously.

Alternatively, as shown in FIG. 9, the secondary tubes may be advanced into the primary tubes until each eyepiece reaches a predetermined, minimum distance from its associated primary tube. As depicted in FIG. 9, this may occur when an edge portion 80 of each eyepiece holder makes contact with one of bearings 50. However, it should be appreciated that other methods of attaining a predetermined distance between the eyepiece holders and the primary tubes are possible, such as providing a stopping member at a fixed distance along an outer surface of each secondary tube, to make contact with the base of the focuser. Once a predetermined distance between the eyepiece holders and the primary tubes is attained, the secondary tubes may be withdrawn from the primary tubes by equal amounts until a desired spacing between eyepieces is attained, as shown in FIG. 10, at which point the optical path lengths of the two telescopes will be substantially equal.

Binocular apparatus 10 may also include one or more alignment mechanisms adapted to align optical axes O and O′. Such alignment is desirable in order to attain substantially similar images via the two telescopes, so that the images may converge to form a single coherent image when viewed simultaneously through two eyepieces. Viewing such a coherent image with two eyes may be more comfortable for an observer, and may have certain other advantages over viewing an image with one eye, including improved image perception. One method of alignment involves pivoting each telescope sequentially in a different orthogonal direction, as described below.

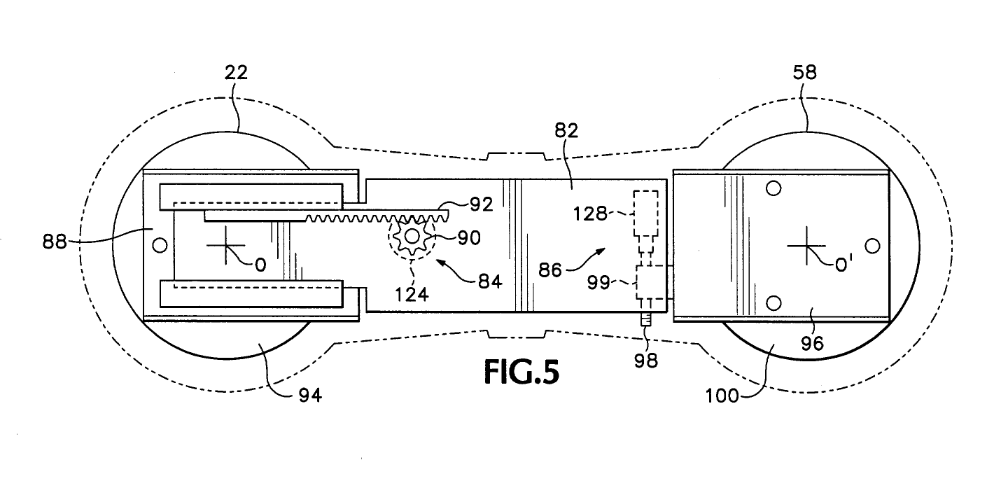

FIG. 5 shows an end view of binocular apparatus 10, including primary optical tubes 22 and 58 attached to an end section 82 of body portion 14 of the binocular apparatus. Also shown are two alignment mechanisms 84 and 86, which are adapted to adjust orientation of the optical axes of the telescopes. First alignment mechanism 84, depicted in FIG. 5 as a rack and pinion assembly, is attached to a first end plate 88 of body portion 14, such that rotation of a pinion 90 causes linear motion of a rack 92 and end plate 88, which is rigidly connected to the rack. Thus, rotation of pinion 90 causes pivoting of optical axis O such that an end portion 94 of the first telescope moves along a first axis (horizontally in FIG. 5). Similarly, second alignment mechanism 86, depicted in FIG. 5 as a threaded shaft assembly, is attached to a second end plate 96 of body portion 14 such that rotation of a threaded shaft 98 within a threaded block 99 causes pivoting of optical axis O′ such that an end portion 100 of the second telescope moves along a second axis orthogonal to the first axis (vertically in FIG. 5).

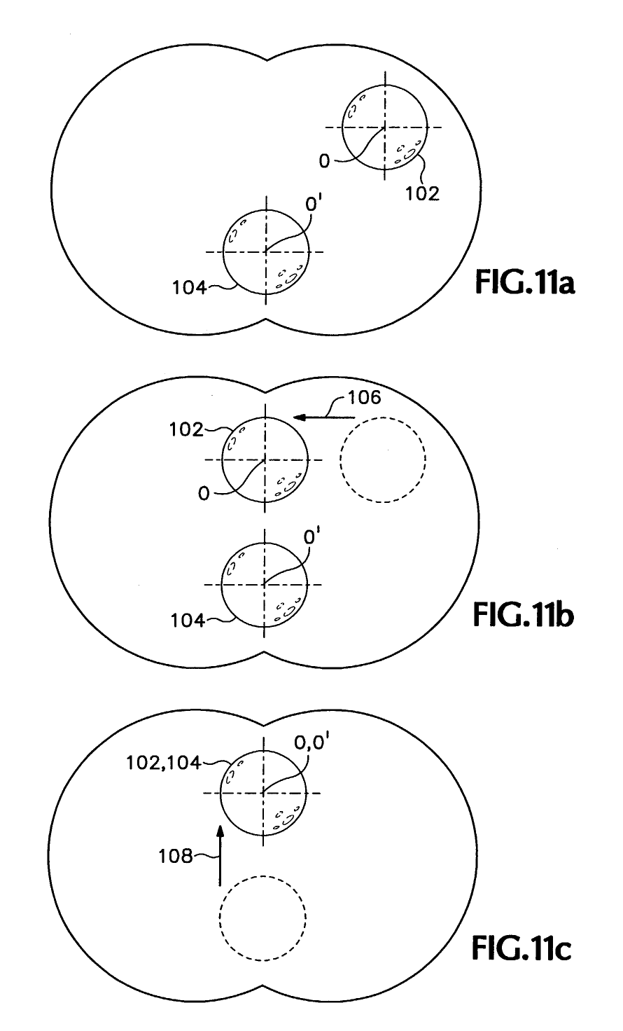

FIGS. 11 a-c schematically depict how alignment mechanisms 84 and 86 may be used to align the two telescopes of the binocular apparatus. FIG. 11a depicts two images 102 and 104 of a distant object, such as a planet, viewed through the eyepieces of the binocular apparatus when the telescopes of the apparatus are not correctly aligned. FIG. 11b depicts an intermediate view through the two eyepieces, after first alignment mechanism 84 has been used to pivot optical axis O of the first telescope. As indicated by arrow 106, the first telescope has been pivoted until image 102 formed via the first telescope and image 104 formed via the second telescope are aligned substantially vertically when viewed simultaneously through the two eyepieces. FIG. 11c depicts a view through the two eyepieces after second alignment mechanism 86 has been used to pivot optical axis O′ of the second telescope. As indicated by arrow 108, the second telescope has been pivoted until optical axes O and O′ coincide, so that image 102 and image 104 converge to form a single image.

Although the method described above includes aligning two images vertically before causing them to converge to form a single image, it should be appreciated that other sequential, orthogonal adjustments of optical axes O and O′ are possible. For example, optical axis O′ may be pivoted first, until the two images are aligned substantially horizontally, and then optical axis O may be pivoted until the optical axes coincide. A general orthogonal alignment process includes pivoting one optical axis in a first direction until the two images are aligned parallel to some alignment axis, followed by pivoting the other optical axis in a second direction, orthogonal to the first direction, until the two images converge to form a single image. Furthermore, although the method has been described in the context of aligning two telescopes in a binocular telescope apparatus, it is generally applicable to aligning any two optical devices.

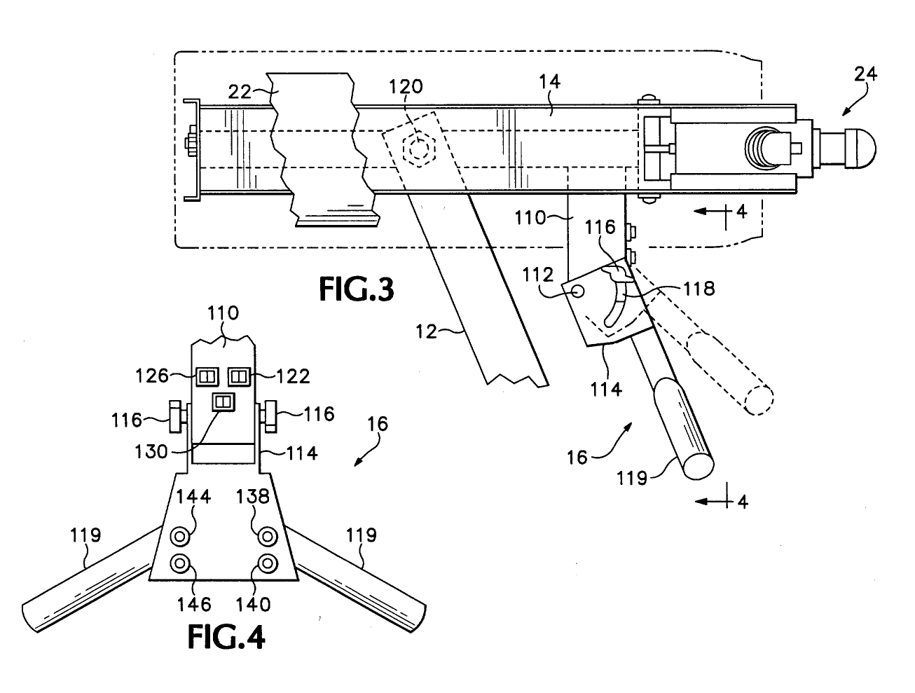

FIGS. 3-4 show details of handlebar apparatus 16 that may be attached to the body portion of the binocular telescope to allow manual control of overall orientation of the binocular apparatus. As is best seen in FIG. 3, handlebar apparatus 16 may be hingably attached to body portion 14 via a connecting member 110. Connection may be made, for example, using a pin 112 inserted through a mounting portion 114 of the handlebar apparatus, and a wing nut 116 may be tightened through a cutout 118 in the mounting portion to allow the handlebar to be positioned at various angles relative to connecting member 110.

Handlebar apparatus 16 may include a pair of handles 119 for adjusting orientation of the binocular apparatus. Body portion 14 of the binocular apparatus may be hingably mounted onto base portion 12 via a frictionally engaging nut assembly 120, so that the handlebar apparatus may be used to control the altitude towards which the binocular apparatus points. Base portion 12 may be rotatably mounted onto a supporting tripod (not shown), so that the handlebar apparatus may also be used to control the azimuthal angle towards which the binocular apparatus points.

As depicted in FIG. 4, handlebar apparatus 16 and connecting member 110 may include a plurality of controls used to control various motions of the components of the binocular apparatus. For example, a first rocker switch 122 may control orientation of optical axis O of the first telescope, by actuating a motor 124 coupled to pinion 90 of alignment mechanism 84. Similarly, a second rocker switch 126 may control orientation of optical axis O′ of the second telescope, by actuating another motor 128 coupled to threaded shaft 98 of alignment mechanism 86. A center toggle switch 130 may function as an eyepiece spacing control. For example, switch 130 may be used to actuate a motor 132 for advancing secondary optical tube 28 towards and away from primary optical tube 22, and switch 130 may simultaneously actuate another motor similar to motor 132 for advancing secondary optical tube 64 towards and away from primary optical tube 58.

In some embodiments, bases 26 and 62 may be moved manually to focus the telescopes, by pushing or pulling on focusers 24 and 60 so as to slide the bases along the sides of their respective primary optical tubes and thereby to focus the two telescopes. However, in the depicted embodiment, the focusers include mechanisms allowing precisely controlled motions of the bases. For example, FIGS. 6 and 7 depict focuser 24 including a threaded shaft 134 connected to base 26, and a threaded block 136 connected to the side of primary tube 22 such that rotation of shaft 134 causes the base to move parallel to optical axis O. Push buttons 138 and 140 on handlebar apparatus 16 may function as focus controls of first telescope 18, by actuating a motor 142 that causes rotation of shaft 134, thereby moving focuser 24 towards and away from primary mirror 36. Similarly, push buttons 144 and 146 may function as focus controls of second telescope 20, by actuating a similar motor that advances focuser 60 towards and away from primary mirror 70 in an analogous manner.

While the present description has been provided with reference to the foregoing embodiments, those skilled in the art will understand that many variations may be made therein without departing from the spirit and scope defined in the following claims. The description should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring, nor excluding, two or more such elements.

1. (Cancel)

2. (Cancel)

3. (Cancel)

4. (Cancel)

5. (Cancel)

6. (Cancel)

7. (Cancel)

8. A binocular apparatus, comprising:
a first primary optical tube having a first primary optical axis enclosing a first primary mirror and movably connected to a first eyepiece;
a second primary optical tube having a second primary optical axis enclosing a second primary mirror and movably connected to a second eyepiece;
a first base secured to the first primary optical tube and movable in a direction generally parallel to an the first primary optical axis of the first primary optical tube;
a second base secured to the second primary optical tube and movable in a direction generally parallel to an the second primary optical axis of the second primary optical tube;
a first secondary optical tube movably engaged with the first base and operatively secured to a first eyepiece holder adapted to receive the first eyepiece, the first secondary optical tube being movable in a direction generally parallel to the first primary optical axis of the first primary optical tube and also being movable in a direction generally orthogonal to the first primary optical axis of the first primary optical tube; and
a second secondary optical tube movably engaged with the second base and operatively secured to a second eyepiece holder adapted to receive the second eyepiece, the second secondary optical tube being movable in a direction parallel to the second primary optical axis of the first primary optical tube and also being movable in a direction generally orthogonal to the second primary optical axis of the first primary optical tube.

9. (Cancel)

10. (Cancel)

11. (Cancel)

12. (Cancel)

13. (Cancel)

14. (Cancel)

15. (Cancel)

16. (Cancel)

17. (Cancel)

18. (Cancel)

19. (Cancel)

20. (Cancel)

21. (Cancel)

22. (Cancel)

23. (Cancel)

24. (Cancel)

25. (Cancel)

26. (Cancel)

27. (Cancel)

28. (Cancel)

29. (Cancel)

30. (Cancel)

31. (Cancel)

32. (Cancel)

33. A binocular apparatus, comprising:
a first primary optical tube having a first optical axis;
a second primary optical tube having a second optical axis;
a first base associated with the first primary optical tube and movable generally parallel to the first optical axis;
a second base associated with the second primary optical tube and movable generally parallel to the second optical axis;
a first secondary optical tube mounted for movement with the first base generally parallel to the first optical axis, and also for movement relative to the first base generally orthogonal to the first optical axis; and
a second secondary optical tube mounted for movement with the second base generally parallel to the second optical axis, and also for movement relative to the second base generally orthogonal to the second optical axis.

34. The binocular apparatus of claim 33, which further comprises:
a first mirror arrangement including a first primary mirror substantially enclosed within the first primary tube and a first secondary mirror mounted for movement along the first optical axis with corresponding movement of the first base; and
a second mirror arrangement including a second primary mirror substantially enclosed within the second primary tube and a second secondary mirror mounted for movement along the first optical axis with corresponding movement of the second base.

35. The binocular apparatus of claim 34, further comprising:
a first advancement mechanism adapted to cause the first secondary optical tube to move generally orthogonal to the first optical axis in concert with movement of the first secondary optical tube generally parallel to the first optical axis so as to preserve focus along a first optical path; and
a second advancement mechanism adapted to cause the second secondary optical tube to move generally orthogonal to the second optical axis in concert with movement of the second secondary optical tube generally parallel to the second optical axis so as to preserve focus along a second optical path.

36. The binocular apparatus of claim 35, wherein the first and second advancement mechanisms are motor-driven.

37. The binocular apparatus of claim 36, wherein the first secondary optical tube employs a first eyepiece, and the second secondary optical tube employs a second eyepiece, and wherein movement of the first and second secondary optical tubes generally orthogonal to respective optical axes adjusts distance between the first and second eyepieces, the first and second advancement mechanisms being adapted to effect positioning of each eyepiece a predetermined distance from a respective optical axis, and then to effect movement of the eyepieces relative to the respective optical axes by approximately equal amounts until a desired spacing between the eyepieces is attained.

38. The binocular apparatus of claim 35, which further comprises
a body portion configured to support the first and second primary optical tubes;
a first alignment mechanism configured to adjust orientation of the first optical axis by moving an end portion of the first optical tube in a first direction until a first image formed via the first optical tube and a second image formed via the second optical tube are aligned substantially parallel to an alignment axis; and
a second alignment mechanism configured to adjust orientation of the second optical axis by moving an end portion of the second optical tube in a second direction substantially orthogonal to the first direction until the first and second images converge to form a single image.

39. The binocular apparatus of claim 33, wherein the first secondary optical tube employs a first eyepiece, and the second secondary optical tube employs a second eyepiece, and wherein the binocular apparatus further comprises an eyepiece spacing adjustment mechanism for adjusting distance between the first and second eyepieces, the eyepiece spacing adjustment mechanism being adapted to position each eyepiece a predetermined minimum distance from a respective optical axis, and then to move the eyepieces away from the respective optical axes by approximately equal amounts until a desired spacing between the eyepieces is attained.

40. The binocular apparatus of claim 33, which further comprises:
a body portion configured to support the first and second primary optical tubes;
a first alignment mechanism configured to adjust orientation of the first optical axis by moving an end portion of the first optical tube in a first direction until a first image formed via the first optical tube and a second image formed via the second optical tube are aligned substantially parallel to an alignment axis; and
a second alignment mechanism configured to adjust orientation of the second optical axis by moving an end portion of the second optical tube in a second direction substantially orthogonal to the first direction until the first and second images converge to form a single image.

41. The binocular apparatus of claim 40, wherein the end portions of the first and second primary optical tubes are distal end portions.

42. The binocular apparatus of claim 41, wherein the first primary optical tube is attached to a first end plate of the body portion such that motion of the first end plate causes the end portion of the first primary optical tube to move, and wherein the second primary optical tube is attached to a second end plate of the body portion such that motion of the second end plate causes the end portion of the second primary optical tube to move.

43. The binocular apparatus of claim 42, wherein one of the alignment mechanisms includes a rack rigidly connected to a corresponding end portion, and a rotatable pinion adapted to cause linear motion of the rack when rotated so as to effect linear motion of the corresponding end portion.

44. The binocular apparatus of claim 42, wherein one of the alignment mechanisms includes a threaded block connected to a corresponding end portion, and a rotatable threaded shaft engaged with the block and adapted to cause linear motion of the block when rotated so as to effect linear motion of the corresponding end portion.

45. The binocular apparatus of claim 42, wherein the first alignment mechanism includes a rack rigidly connected to the first end portion and a rotatable pinion adapted to cause linear motion of the rack when rotated so as to effect linear motion of the first end portion, and wherein the second alignment mechanism includes a threaded block connected to the second end portion and a rotatable threaded shaft engaged with the block and adapted to cause linear motion of the block when rotated, so as to effect linear motion of the second end portion.

46. The binocular apparatus of claim 40, wherein the first primary optical tubes forms a part of a first reflecting telescope, and the second primary optical tube forms a part of a second reflecting telescope.

47. The binocular apparatus of claim 33, which further comprises:
a base portion;
a body portion hingably attached to the base portion, and carrying the first and second primary optical tubes; and
a handlebar apparatus attached to the body portion to accommodate manual adjustment of body portion orientation, the handlebar apparatus including controls to adjust at least one characteristic of an image formed via the first and second primary optical tubes.

48. The binocular apparatus of claim 47, wherein the controls include a first optical axis alignment control configured to direct pivot of the first primary optical tube in a first direction, and a second optical axis alignment control configured to direct pivot of the second primary optical tube in a second direction substantially orthogonal to the first direction.

49. The binocular apparatus of claim 47, wherein the controls include an eyepiece spacing control configured to direct adjustment of spacing between a first eyepiece associated with the first secondary optical tube and a second eyepiece associated with the second secondary optical tube.

50. The binocular apparatus of claim 47, wherein the controls include a first focus control configured to direct adjustment of focus of an image formed via the first primary optical tube, and a second focus control configured to direct adjustment of focus of an image formed via the second primary optical tube.

51. The binocular apparatus of claim 47, wherein the controls include a first alignment control configured to direct adjustment of orientation of a first primary optical tube, a second alignment control configured to direct adjustment of orientation of a second primary optical tube, an eyepiece spacing control configured to direct adjustment of spacing between a first eyepiece associated with the first secondary optical tube and a second eyepiece associated with the second secondary optical tube, a first focus control configured to direct adjustment of focus of an image formed via the first primary optical tube, and a second focus control configured to direct adjustment of focus of an image formed via the second primary optical tube.

52. A binocular apparatus, comprising:
a first telescope; and
a second telescope;
wherein each telescope includes primary and secondary optical tubes, each secondary optical tube being mounted on a base for movement generally parallel to an optical axis of the primary optical tube, and for coordinated movement generally orthogonal to the optical axis of the primary optical tube.

53. The binocular apparatus of claim 52, wherein each telescope further includes a primary mirror substantially enclosed within the first primary tube to focus received light and a secondary mirror mounted for movement generally along the optical axis with the secondary optical tube to direct light reflected by the primary mirror through the secondary optical tube to an eyepiece.

54. The binocular apparatus of claim 53, wherein movement of the secondary mirror generally along the optical axis effectively changes a length of an optical path of a corresponding telescope, and wherein coordinated movement of the secondary optical tube orthogonal to the optical axis compensates for such change in length of the optical path.

55. The binocular apparatus of claim 52, wherein each telescope further includes a mirror configured to direct light passing through the secondary optical tube to an eyepiece configured to face a direction generally parallel to the optical axis of the primary optical tube.

56. The binocular apparatus of claim 55, wherein the binocular apparatus further comprises an eyepiece spacing adjustment mechanism for adjusting distance between eyepieces of the first and second telescopes, the eyepiece spacing adjustment mechanism being adapted to position each eyepiece a predetermined minimum distance from a respective optical axis, and then to move the eyepieces away from the respective optical axes by approximately equal amounts until a desired spacing between the eyepieces is attained.

57. The binocular apparatus of claim 56, wherein the secondary optical tubes are configured for movement generally parallel to a corresponding optical axis to effectively change a length of an optical path of a corresponding telescope, and wherein the eyepiece spacing adjustment mechanism is configured to coordinate movement of the eyepieces away from the respective optical axes by approximately equal amounts to compensate for such changes in length of the optical path, while maintaining co-planar placement of the eyepieces.

58. The binocular apparatus of claim 52, which further comprises:
a body portion configured to support the first and second telescopes;
a first alignment mechanism configured to adjust orientation of the first telescope by moving an end portion of the primary optical tube of the first telescope in a first direction until a first image formed by the first telescope and a second image formed by the second telescope are aligned substantially parallel to an alignment axis; and
a second alignment mechanism configured to adjust orientation of the second telescope by moving an end portion of the primary optical tube of the second telescope in a second direction substantially orthogonal to the first direction until the first and second images converge to form a single image.

59. The binocular apparatus of claim 52, which further comprises:
a base portion;
a body portion hingably attached to the base portion, and carrying the first and second telescopes; and
a handlebar apparatus attached to the body portion to accommodate manual adjustment of body portion orientation, the handlebar apparatus including controls to adjust at least one characteristic of an image formed by the first and second telescopes.

60. A binocular apparatus, comprising:
a first telescope means; and
a second telescope means;
wherein each telescope means includes primary and secondary optical tube means, each secondary optical tube means being mounted on a base means for movement generally parallel to an optical axis of the primary optical tube means, and for coordinated movement generally orthogonal to the optical axis of the primary optical tube means.

61. The binocular apparatus of claim 60, wherein each telescope means further includes mirror means configured to direct light passing through the secondary optical tube means to eyepiece means configured to face a direction generally parallel to the optical axis of the primary optical tube means.

62. The binocular apparatus of claim 61, which further comprises means for adjusting distance between eyepieces of the first and second telescopes by positioning each eyepiece means a predetermined minimum distance from a respective optical axis, and then moving the eyepiece means away from the respective optical axes by approximately equal amounts until a desired spacing between the eyepiece means is attained.

63. The binocular apparatus of claim 62, wherein the secondary optical tube means are configured for movement generally parallel to a corresponding optical axis to effectively change a length of an optical path of a corresponding telescope means, and wherein means for adjusting distance between eyepieces is configured to coordinate movement of the eyepiece means away from the respective optical axes by approximately equal amounts to compensate for such changes in length of the optical path, while maintaining co-planar placement of the eyepiece means.

64. The binocular apparatus of claim 60, which further comprises:
a body means for supporting the first and second telescope means;
a first alignment means configured to adjust orientation of the first telescope means by moving an end portion of the primary optical tube means of the first telescope means in a first direction until a first image formed by the first telescope means and a second image formed by the second telescope means are aligned substantially parallel to an alignment axis; and
a second alignment means configured to adjust orientation of the second telescope means by moving an end portion of the primary optical tube of the second telescope means in a second direction substantially orthogonal to the first direction until the first and second images converge to form a single image.
